(19) United States
(12) Patent Application Publication
(10) Pub. No.: US 2016/0292165 A1
(43) Pub. Date: Oct. 6, 2016

(54) APPARATUS AND SYSTEMS FOR ARCHIVING INFORMATION AND METHODS THEREOF

(71) Applicant: Solu Publishing, Inc., Ketchum, ID (US)

(72) Inventor: Stephen White, Ketchum, ID (US)

(21) Appl. No.: 15/018,578

(22) Filed: Feb. 8, 2016

Related U.S. Application Data
(60) Provisional application No. 62/113,299, filed on Feb. 6, 2015.

(51) Int. Cl. G06F 17/30; G06F 3/0484

(52) U.S. Cl. CPC G06F 17/30073; G06F 17/30424; G06F 3/0484

(57) ABSTRACT

The present invention provides an engine, system and method for providing more automated and efficient process and methodology for providing for the collection and archiving of personal information.

### CROSS-REFERENCE TO RELATED APPLICATIONS

This application claims priority to U.S. Provisional Application Ser. No. 62/113,299, filed Feb. 6, 2015, the entirety of which is incorporated herein by reference.

### FIELD OF THE INVENTION

The present invention relates to archiving information, and, more particularly, to an engine, system and method of soliciting and archiving personal information for access and use by at least one future user.

### BACKGROUND

During the course of a human life, much information is created and often allowed to become lost or destroyed. Pictures of family gatherings, pictures of vacations, news of special events, invitations to special occasions, baby books, school yearbooks, art projects, medals and ribbons won for achievements, letters written to loved ones, legal papers, video/voice recordings, and other types of media which a person might keep in a scrapbook and/or a place of safekeeping to preserve an important memory for themselves and current and/or future. Such information might be valuable for future consumption by family members, loved ones or other interested in the life and history of an individual who has passed.

Thus, there exists the need for an engine and storage method for the archiving of information allow for personal information to be accessible by third parties after it is deposited.

### SUMMARY

The present invention provides an engine, system and method for providing more automated and efficient process and methodology for providing for the collection and archiving of personal information. Such a system may allow for the burdensome and otherwise inefficient collection mechanisms generally associated with archiving activities. The present invention may also act as a tool to interconnect and collect and or access images and other digitally accessible data remotely from the entire system using handheld devices. The present invention may be easily deployable on any internet accessible device and may work within existing technology infrastructures, and may be deployed as a thin client and/or user-transparent client, and may further provide for cross-platform communication between systems and devices not otherwise communicatively compatible.

It is to be understood that both the foregoing general description and the following detailed description are exemplary and explanatory, and are intended to provide further explanation of the invention as discussed herein throughout.

### BRIEF DESCRIPTION OF THE DRAWINGS

The accompanying drawings are included to provide a further understanding of the disclosed embodiments. In the drawings:

FIG. 1 is a block diagram of an exemplary computing system for use in accordance with herein described systems and methods;

FIG. 2 illustrates an exemplary embodiment of the present invention;

FIG. 3 illustrates exemplary embodiment of the present invention;

FIG. 4 illustrate exemplary embodiments of the present invention;

FIG. 5 illustrate exemplary embodiments of the present invention;

FIG. 6 illustrates an exemplary embodiment of the present invention;

FIG. 7 is a block diagram of an exemplary computing system for use in accordance with herein described systems and methods;

FIG. 8 illustrates an exemplary embodiment of the present invention;

FIG. 9 illustrates an exemplary embodiment of the present invention;

FIG. 10 illustrates an exemplary embodiment of the present invention;

FIG. 11 illustrates an exemplary embodiment of the present invention;

FIG. 12 illustrates an exemplary embodiment of the present invention;

FIG. 13 illustrates an exemplary embodiment of the present invention;

FIG. 14 illustrates an exemplary embodiment of the present invention;

FIG. 15 illustrates an exemplary embodiment of the present invention;

FIG. 16 illustrate exemplary embodiments of the present invention;

FIG. 17 illustrate exemplary embodiments of the present invention;

FIG. 18 illustrate exemplary embodiments of the present invention;

FIG. 19 illustrates an exemplary embodiment of the present invention;

FIG. 20 illustrate exemplary embodiments of the present invention;

FIG. 21 illustrates an exemplary embodiment of the present invention;

FIG. 22 illustrates an exemplary embodiment of the present invention; and

FIGS. 23-26 illustrate exemplary embodiments of the present invention;

### DETAILED DESCRIPTION

A computer-implemented platform and methods of use are disclosed that provide more automated and efficient process and methodology for providing flight simulation training and testing. Described embodiments are intended to be exemplary and not limiting. As such, it is contemplated that the herein described systems and methods can be adapted to provide many types of users with access and delivery of many types of simulation and educational data, and can be extended to provide enhancements and/or additions to the exemplary services described. The invention is intended to include all such extensions. Reference will now be made in detail to various exemplary and illustrative embodiments of the present invention.

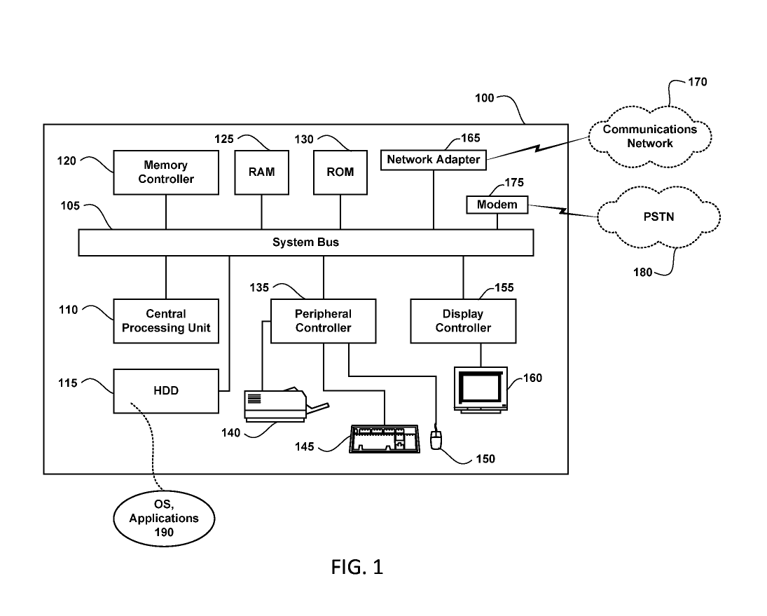

FIG. 1 depicts an exemplary computing system 100 that can be used in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, mobile devices, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output generated by computing system 100. Such visual output may include text, graphics, animated graphics, and/or video, for example. Display 160 may be implemented with a CRT-based video display, an LCD-based display, gas plasma-based display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet, and hence which may provide or include tracking of and access to the domain data discussed herein. Communications network 170 may provide user access to computing system 100 with means of communicating and transferring software and information electronically, and may be coupled directly to computing system 100, or indirectly to computing system 100, such as via PSTN or cellular network 180. For example, users may communicate with computing system 100 using communication means such as email, direct data connection, virtual private network (VPN), Skype or other online video conferencing services, or the like. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

Although people come from many backgrounds, whether secular or religious, cosmopolitan or tribal, wealthy or poor, no group has a well-established and/or relatively easily assessable system for the cataloging of information relative to a person's life and/or special events. This even in the face of a natural demand to provide others in one's culture of the experiences and wisdom obtained during a lifetime. Not only do we wish to share or thoughts and concerns, but we may also wish to preserve a narrative of our lives constructed into a coherent story so as to provide a record which may accurately depict at least a portion of who we are or who we would like to project ourselves. The present invention may allow a user to write and share thoughts about their unique life and experiences in a way that may allow others to discover information about the recorder at a time after the information. For example, a grandmother (or future grandmother) may put in a variety of information into the system which may be retrievable by a third party person through a search and/or simple query as will be more fully explained below.

In an embodiment of the present invention, information may be uploaded by a user for themselves and/or rely on a third party who may work with the user to collect and store the information in a desired format. The present invention may be a mobile first platform which may be resident on/though a plurality of cloud-based storage facilities. The GUI provided with the present invention may provide a question-based and/or prompt-based interface to at least help guide a user through the collection and/or uploading of information. The GUI may be presented in a dynamic fashion responsive to attributes of the user, the information being collected, and/or the mechanism by which collection occurs. Information collected may include meta-data and/or may be collected in a way which may allow the collected data to be geo-tagged and time stamped.

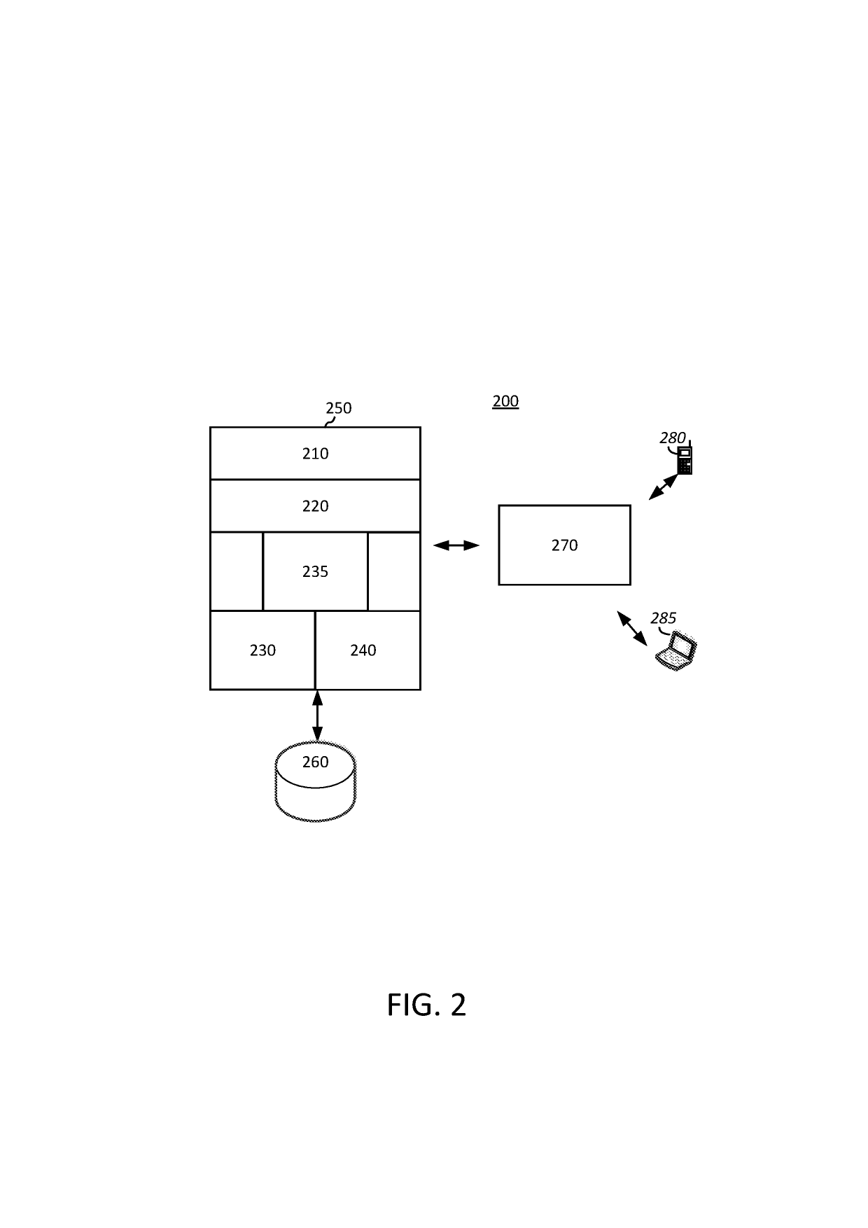

As illustrated in FIG. 2, the system 200 may be resident on at least one internet accessible server and may be securely resident thereon. The system 200 may include at least one access server 250 which may house a collection engine 230 and query engine 240 and at least one database 260. The collection engine 230 and the query engine 240 may be communicatively connected to allow for enhance performance of the system and, in particular, to allow for the dynamic enhancement of the accessibility of the system 200 by the interaction engine 235.

Access to the system 200 may be through any internet accessible device and may take the form of a mobile device 280, for example, versus a traditional terminal computer 285. In an embodiment of the present invention, a user of the mobile device 280 may interact with the GUI module 270 which may present to the user with at least initial access to the system 200 and may, for example, determine attributes of the user. Such user attributes may include, for example, the type of device the user is using to access system 200, the time of access, the location of the user, and contact information. The GUI module 270 may provide a gateway into access server 250 and may, for example, provide a first level of security by detecting a bot and/or requiring a first password. A decision point may also be presented at GUI module 270 to direct a user to a login page, a new user sign up page, and/or demo/guide to inform the user of the use of the present invention. One or more of the directed to functions may reside at GUI module 270 and/or at access server 250.

In an embodiment of the present invention, the access server 250 may include at least one authentication layer 210 may identify and authentic users previously registered with the system 200. Similarly, authentication layer 210 may provide administrative functionality which may allow users and administrators to add users to the system, add users to security or family groups (discussed herein below) as needed, while auditing authentication and authorization rules which may accompany use of the system by any user. The present invention may also interface successfully with authentication and authorization systems located remote from the system that may be capable of hooking into the authentication/authorization components already implemented by a system user, such as, for example, an app associated with the present invention.

In an embodiment of the present invention, traditional terminal computer 285 may be a desktop computer, laptop, workstation or router, that is capable of connecting into the access server 250 to establish a session. Traditional terminal computer 285 may incorporate a secure client desktop software containing a computer network authentication protocol employing strong encryption, preferably IPsec. This Internet security protocol allows for cryptographic key establishment and authenticating and/or encrypting each IP packet in a data stream. IPsec or other like protocol is preferable because it functions at the network layer, which gives it more flexibility than many other security protocols in common use, such as SSH, SSL/TL and Kerberos, which operate on the transport layer. This difference allows IPsec to secure packet flows.

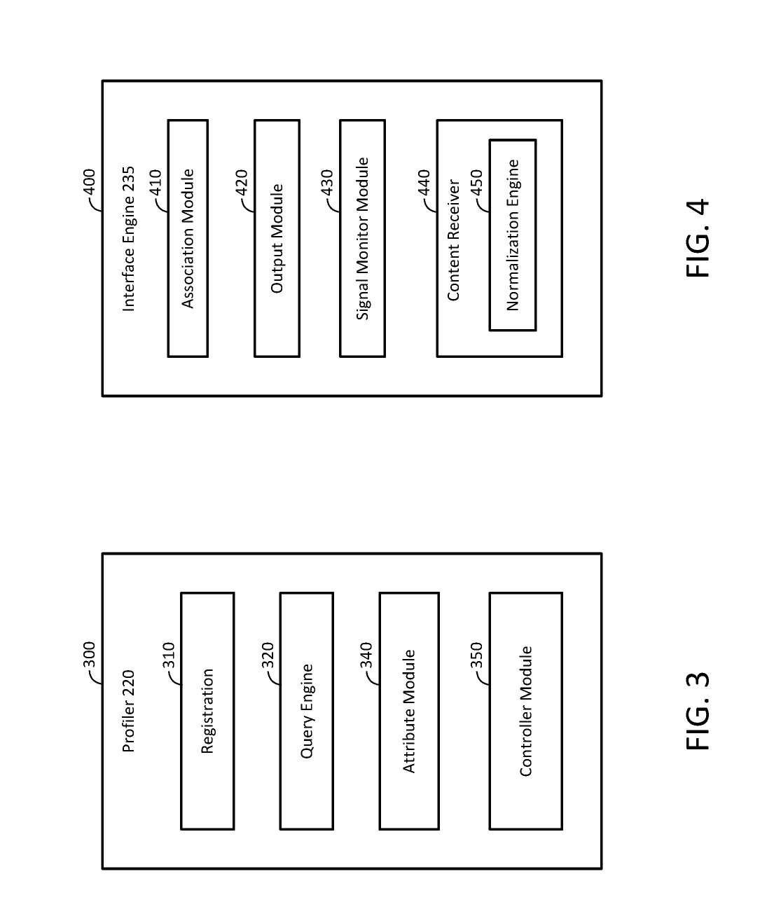

In an embodiment of the present invention, and as illustrated in FIG. 3, access server 250 may include system 300, which may be further operable with profiler 220. Users may pass through authentication layer 210 and may provide information to the profiler in for registration 310 within the system 300. The registration 310 of a user may provide attributes of the user, whether entered by the user directly or gathered in an indirect manner by the system 200, to the remaining modules of the present invention to enhance to performance of the cataloging and prompting for content provided by a user.

To effectuate the provisioning of information, query engine 320 may provide prompts retrieved from a predetermined list and/or dynamically based on elements from the attribute module 340. For example, an attribute of a user may be indicative of the time of day the user generally engages with the device the user utilizes to access the system 200. During that time period provided by the attribute module 340, the controller module 350 may prompt the query engine 320 may push at least one alert and/or prompt to provide information into the system 200. Such a prompt may be, for example, in the form of a question, such as, “What did you do today?” The attribute module 340 may also keep track of current events deemed relevant to the user which may allow the controller module 350 to similarly prompt for a response from the user through query engine 320. By way of non-limiting example only, a user located in a particular country may be asked a questions about a timely event, such as, for example, the election of a high ranking political official.

In an embodiment of the present invention, and as illustrated in FIG. 4, access server 250 may include system 400, which may include interface engine 235, which may further include various input and output modules as well as the engines necessary to collect and normalize received content. As content is submitted by a user, the content receiver 440 may determine the type and size of the content and may, for example, normalized the content by converting received files into one of a discreet set of file forms. For example, photos and documents may be placed in a PDF format where certain forms of meta data may be removed and certain images may be flattened to allow for the saving of data storage space. As would be appreciated by those skilled in the art, any designated format may be used to accomplish the goal of creating efficiencies of both file type and size.

The interface engine 235 may also provide for the joining of conent with a user's account and/or at least one third person who may be related to the user and/or the media being uploaded into system 200. In an embodiment of the present invention, the association module 410 may link media as between a user and related account, a related event, and/or the account holders own account. For example, a third party may provide content on behalf of another party or wish to associate certain media with a plurality of users who all are related to the same event, such as, for example, were all on a championship team. In this way, the content associated with one of the championship team members may be at least partially accessible to each of the associated championship team members to provide a greater breadth of context to the users' contact with ones of the other users and/or the related event.

The output module 420 may allow for the optimization of a feed to a user based on the user's connection with system 200 and may modify the delivery or request for content through GUI module 270. Such optimization may allow for the converting of image size and the like based on the type of device used by the user and or the connection speed between the user and system 200 and tracked by the signal monitor module 430.

In an embodiment of the present invention, third parties may provide questions or other prompts for information to illicit desired information from at least one user. For example, a father may be a user and at least one child may create questions within the system to be delivered to the father for answering and storing within the father's profile or story. Similarly, the answers to the questions may be shared with the at least one child which may, in turn, prompt additional questions. This may create a virtual conversation, all which may be recorded for use by the father, the child, or other authorized user. As discussed herein, queries to a user may be periodic and may be answered at any time convenient to a user.

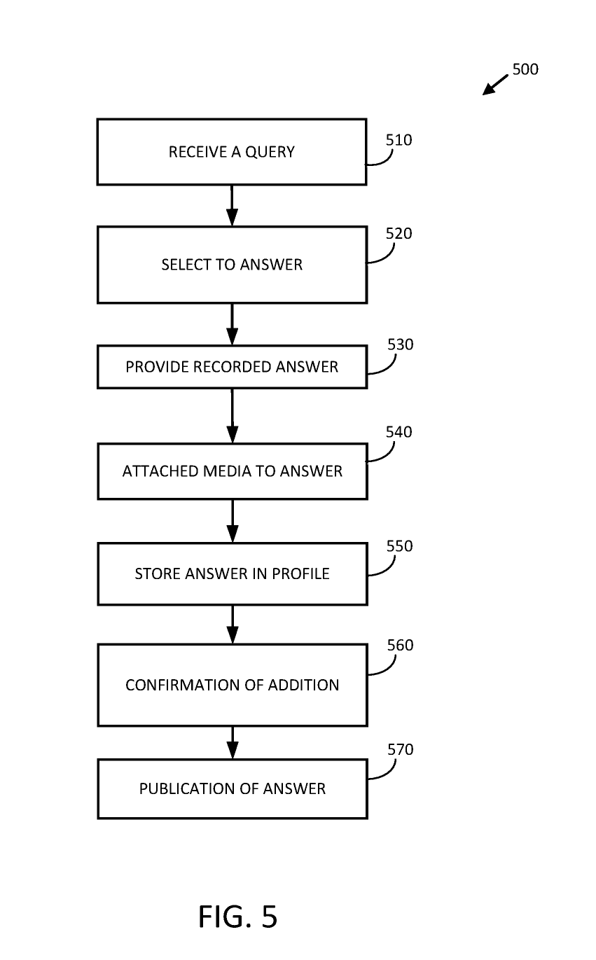

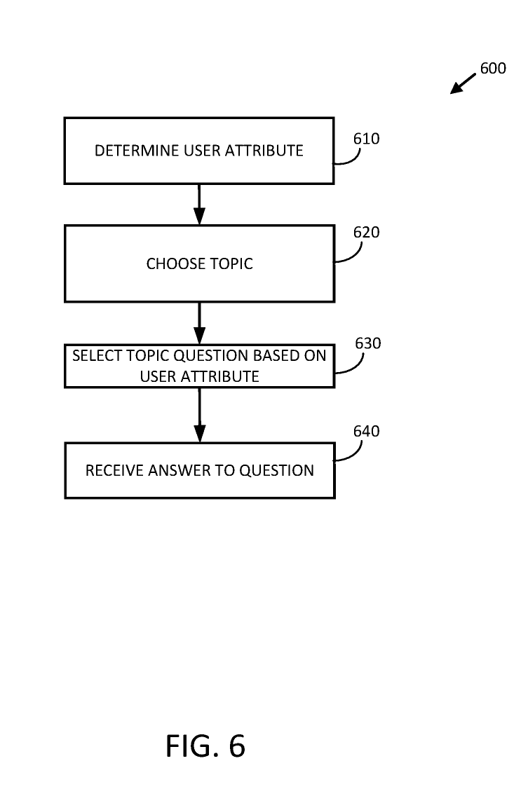

As illustrated in FIGS. 5-6, various steps may be taken within the system as described herein.

FIG. 7 is an example of a simplified functional block diagram of a computer system 700. The functional descriptions of the present invention can be implemented in hardware, software or some combination thereof. For example, a recommendation engine and an integration engine of the present invention can be implemented using a computer system.

As shown in FIG. 7, the computer system 700 includes a processor 702, a memory system 704 and one or more input/output (I/O) devices 706 in communication by a communication ‘fabric’. The communication fabric can be implemented in a variety of ways and may include one or more computer buses 708, 710 and/or bridge and/or router devices 712 as shown in FIG. 7. The I/O devices 706 can include network adapters and/or mass storage devices from which the computer system 700 can send and receive data for generating and transmitting advertisements with endorsements and associated news. The computer system 700 may be in communication with the Internet via the I/O devices 708.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

The various illustrative logics, logical blocks, modules, and engines, described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

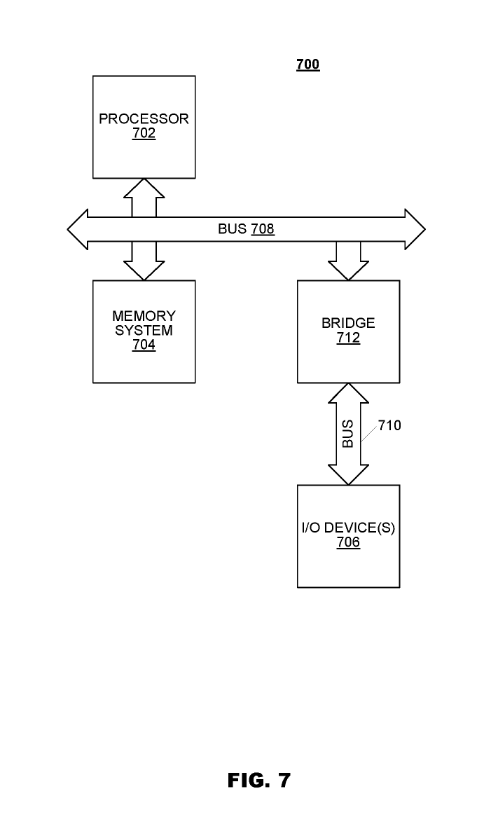

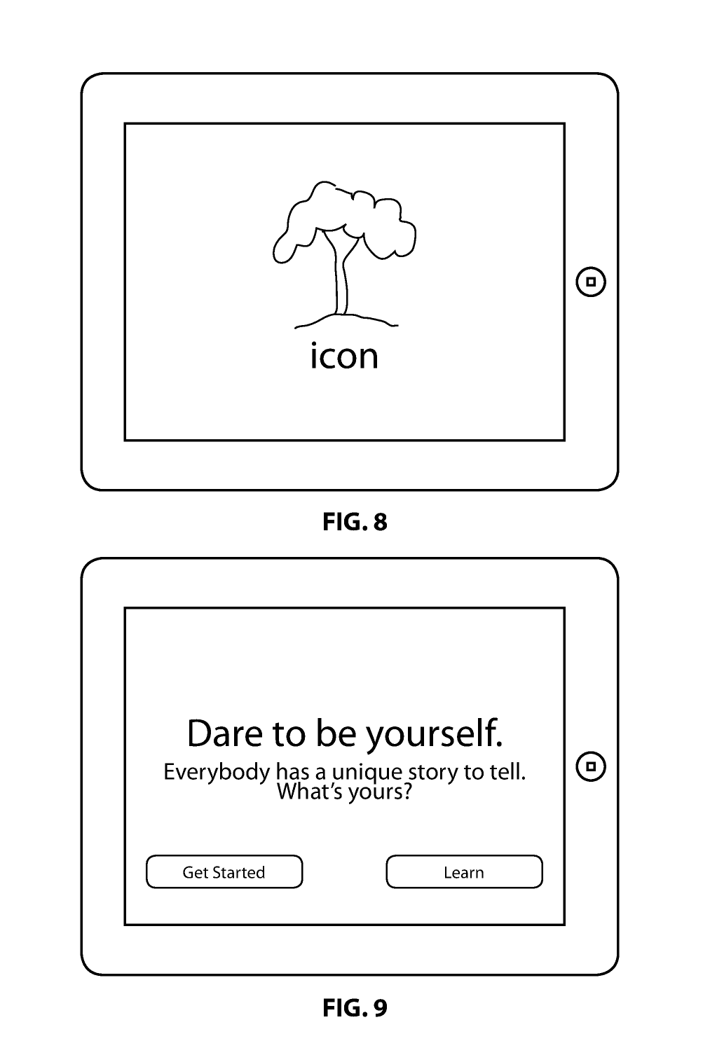

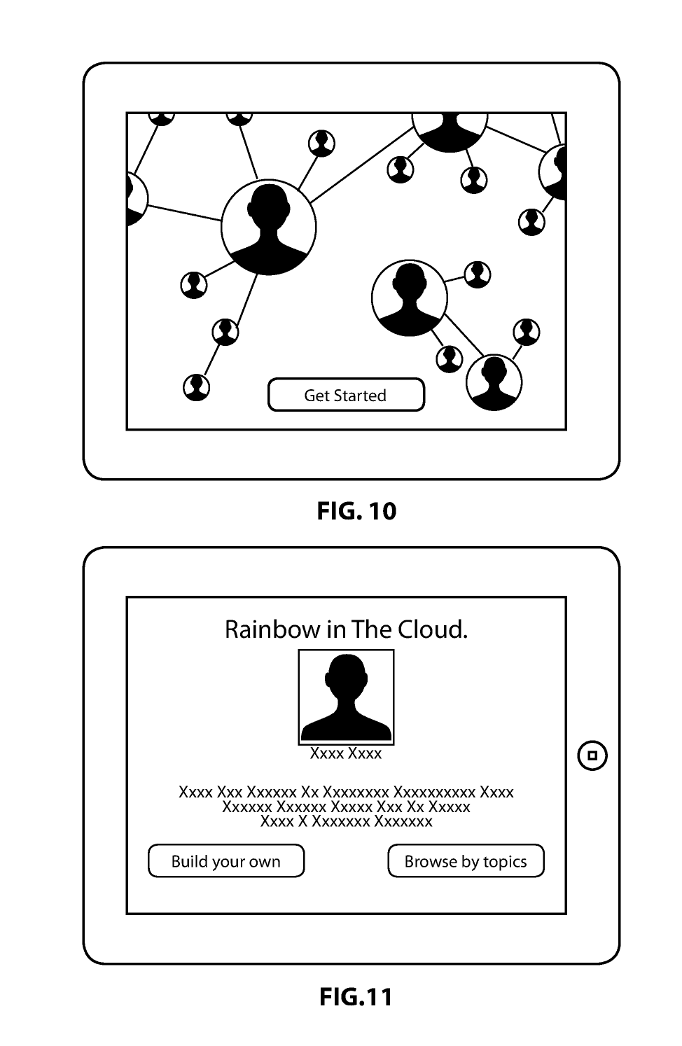

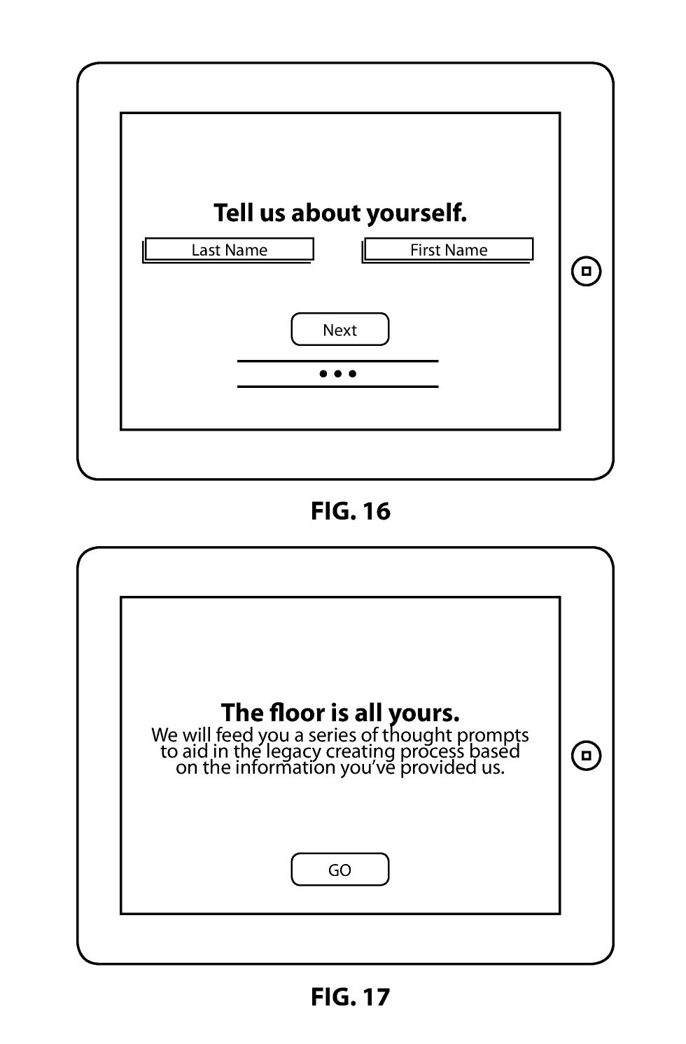

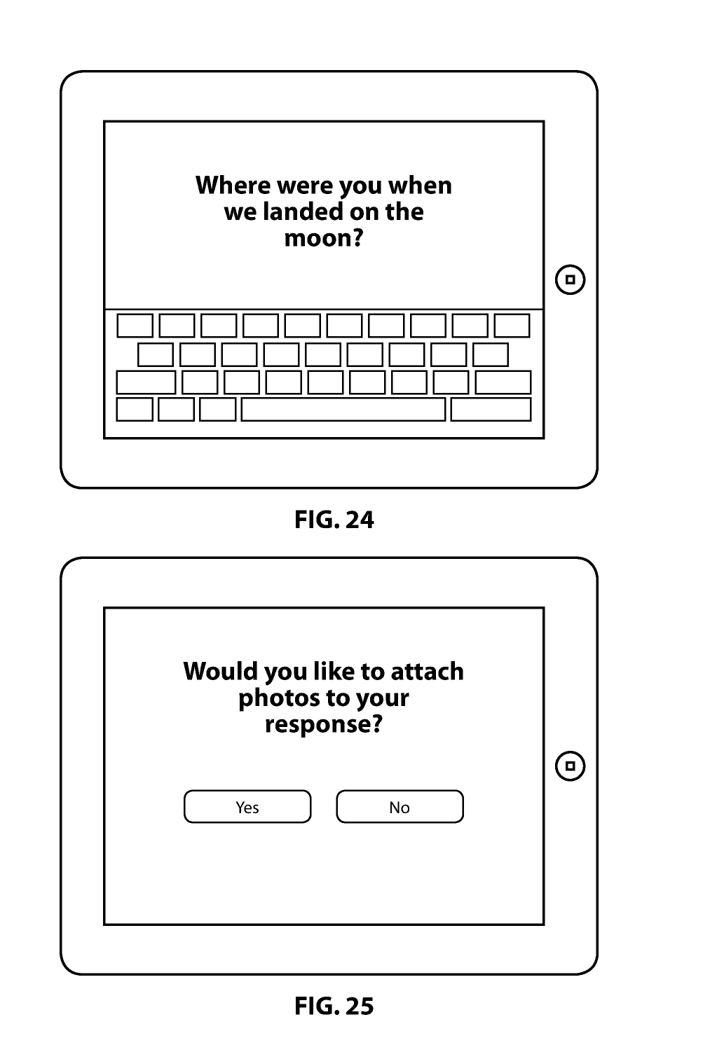

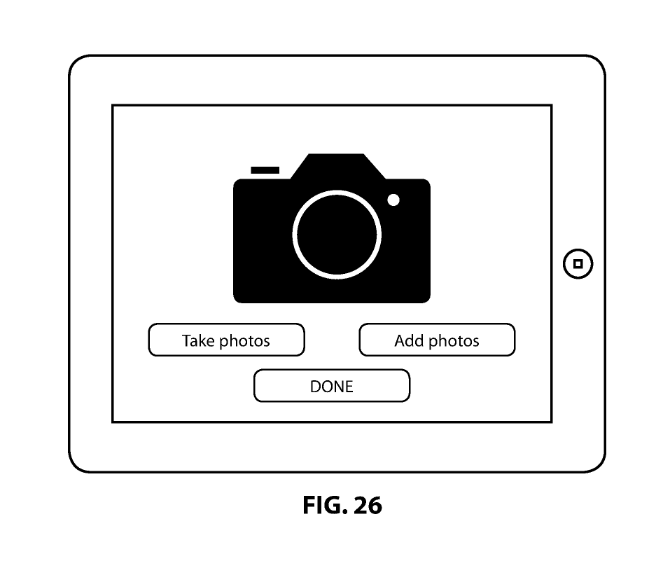

In embodiments of the present invention, FIGS. 8-28 illustrate some of the features discussed herein. As illustrated in FIG. 8 for example, a login screen may be presented while a splash screen, as illustrated in part in FIG. 9, may be provided to convey to the user the purpose of the GUI presented and to provide options for learning more about the platform offered or to get started with platform usage. To inform the user on the benefits of the present invention and to provide some examples by which they may base their own curated story, the user may be presented with a selection of profiles to choose from for viewing purposes as illustrated in FIG. 10. Selecting a particular user, by tapping on an icon, for example, may present the user with a page within the selected user's story, as illustrated in FIG. 11.

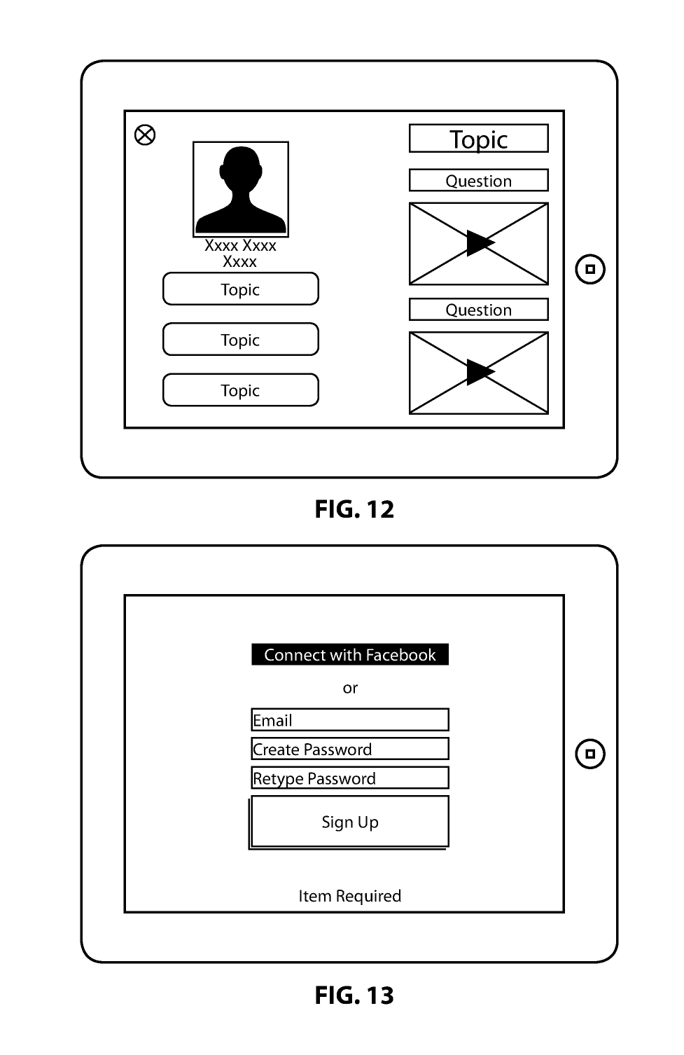

In an embodiment of the present invention, as illustrated in FIG. 12, a user may have associated therewith a series of topics that may encompass any idea or event designated by the user for recordation. Each topic may, for example, also include a question and an answer provided by the user which may be in written form and or electronic submission.

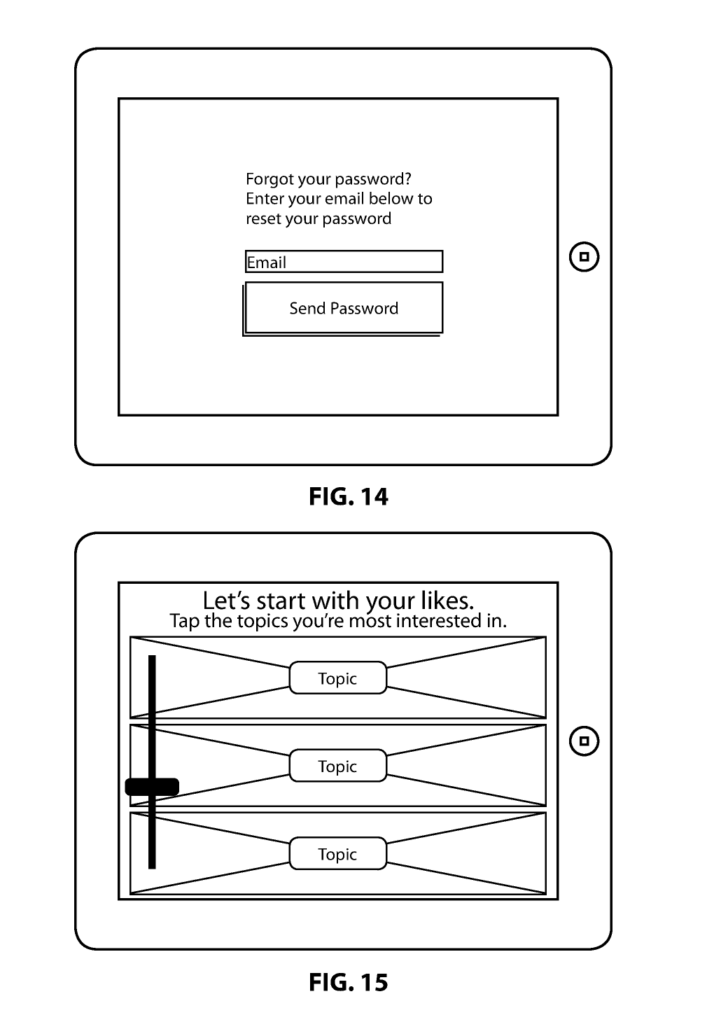

As illustrated in FIG. 13, and as would be appreciated by those skilled in the art, a user may sign into and/or register with the present invention through a prior social media membership and/or by entering some identifying information. Similarly, as illustrated in FIG. 14, the present invention may allow for the recovery of a password or other identifier the user may have within the system.

Once within the system, a user may allow the interface to guide them through the information gathering process. In an embodiment of the present invention, a list of predetermined topics may be represented and/or selected to enage the user with the information gathering process. As illustrated in FIG. 15, for example, a user may scroll through topics in descending order, selecting topics in which they are most interested. Each topic may include at least some image and may, preferably, have included herewith a landscaped image indicative of the topic to provide a visual explanation of the topic. Topics may include such things as, “childhood”, “high school days”, “love”, “relationships”, “college years”, “faith and spirituality”, “historical events”, taking responsibility”, and “friendships”, by way of non-limiting example only.

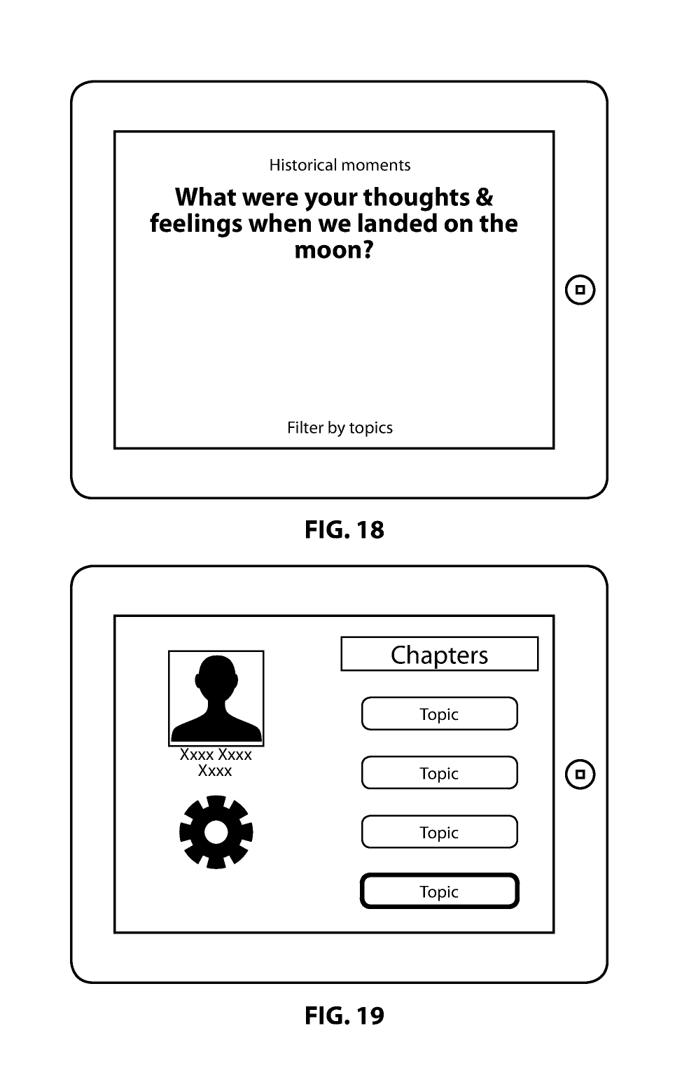

A user may select a topic, such as “historical moments” for example, and be taken to a screen presenting a randomly presented historical question, as illustrated in FIG. 18. This type of auto-generated question may provide the user with at least a first path through populating their story and/or profile within the system. If a question presented is not of interest to the user, a left swipe (for example) of the screen may prompt the system to provide a new question while a right swipe may move the user to a page to answer the question. The user may also “filter” available topics as discussed herein.

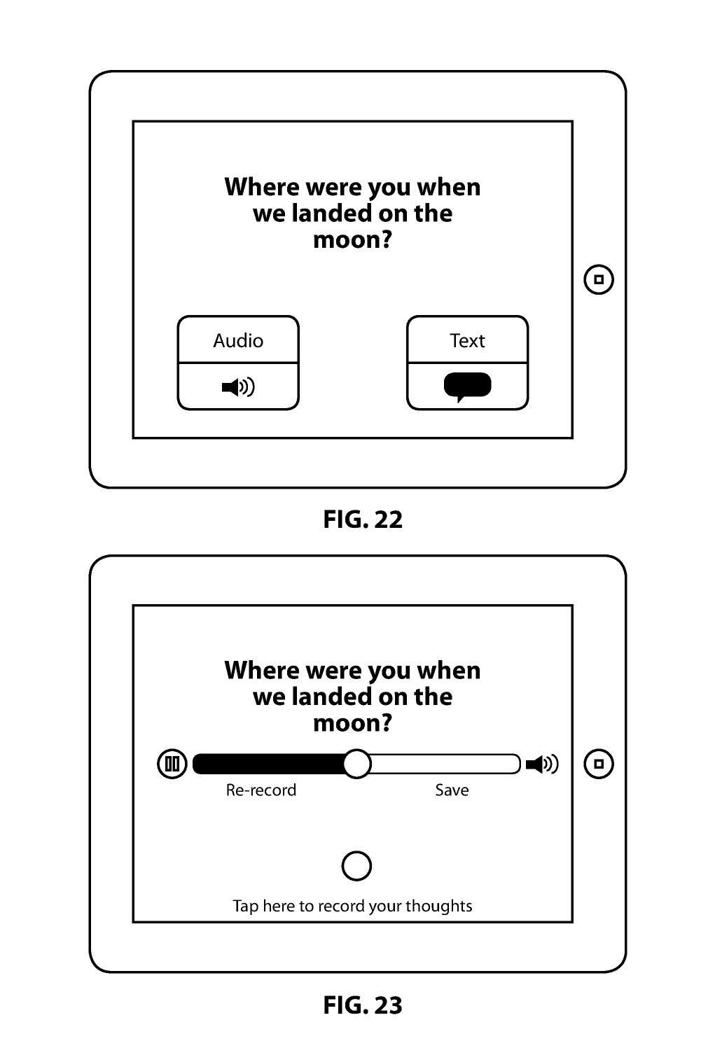

In an embodiment of the present invention and as illustrated in FIG. 22, a right swipe from a topic page may land the user at access to the recordation of an answer to the question. As further illustrated in FIGS. 23-25, voice and written responses may be gathered and saved as a response to each question within each topic. As would be appreciated by those skilled in the arts, video recording may also be accomplished, as well as combinations of recorded material with text. Similarly, a user may attached a link or actual content from some other accessible database—such as, for example, local storage and/or internet cloud service.

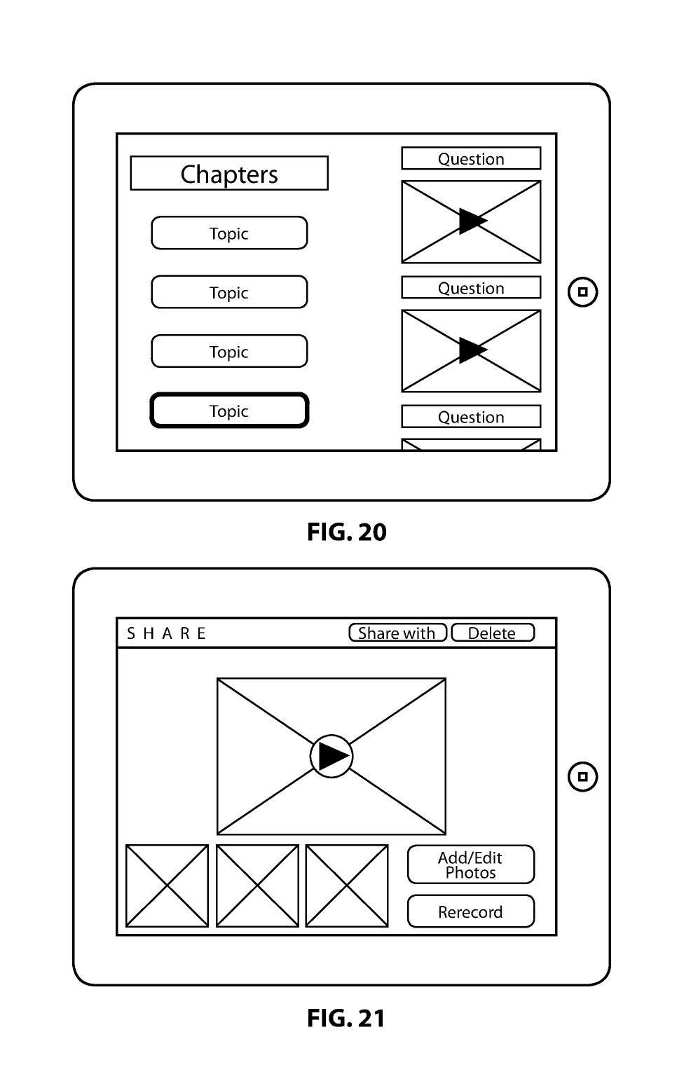

Referring back now to FIGS. 20 and 21, a user may manually add and control the content associated with their profile and/or story. A user may create chapters and topics therein to create a full “story” about at least one aspect of the users' life and our a specific experience. As discussed herein, many different forms of media may be accepted and included in each topic.

Those of skill in the art will appreciate that the herein described systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

What is claimed is:

1. A computer-implemented engine for archiving information, over a network, responsively to input user information comprising at least one unique information input, comprising:
a graphical user interface capable of querying at least one requester for the input user information comprising at least topic related to the user;
at least one network port capable of remotely receiving the user information from said graphical user interface;
at least one collection engine communicatively connected to said at least one network port, and comprising a plurality of rules to generate, responsively to the input user information, at least one unique query of at least one attribute of the user; and
at least one interface engine communicatively connected to at least one rules engine for reporting to a user that least one query of at least one attribute of the user;
wherein the user provides at least one input in response to the at least one query.
